(19) United States
(12) Patent Application Publication
(10) Pub. No.: US 2005/0159149 A1
(43) Pub. Date: Jul. 21, 2005

(54) Network mobile communication device

(76) Inventors: Kuei-Ann Wen, HsinChu (TW); Wen-Shen Wuen, HsinChu (TW)

Correspondence Address: TRANSPACIFIC LAW GROUP, 617 NORTH DELAWARE STREET, SAN MATEO, CA, 94401, US

(21) Appl. No.: 10/745,752

(22) Filed: Dec. 27, 2003

(51) Int. Cl. H04B 7/00; H04M 1/66; H04M 1/68; H04M 3/16; H04Q 7/20; H04M 1/00

(52) U.S. Cl. 455/426.1; 455/411; 455/556.1

(57) ABSTRACT

A network mobile communication device comprising: a control module to connect a mobile handset and to control the operation of the mobile handset; a wireless network operation system to set operational conditions of said network mobile communication device; a wireless network hardware to include electronic components enabling the communication of said network mobile communication device with a local wireless access point; and a wireless network driver module to drive electronic components of said wireless network hardware; wherein: said control module connects said local wireless access point to obtain an authenticated IP address upon the input of identification code of a remote network mobile communication device by user and actuates said connected mobile handset to send data of said obtained IP address to said remote network mobile communication device through mobile communication network system connected to said mobile handset; and said control module connects said local wireless access point upon the receipt of an IP address from a remote network mobile communication device and connects, through said local wireless access point, said remote network mobile communication device represented by said IP address to establish communication.

### FIELD OF THE INVENTION

The present invention relates to a network mobile communication device, especially to a device to be coupled with a mobile communication equipment to enable the mobile communication equipment to communicate through the internet.

### BACKGROUND OF THE INVENTION

The most popular mobile communication equipment is the system called the mobile phone. In such a system, a plurality of base stations is widely installed within the operational territory by the system operator to form a cellular network. If the mobile communication device, e.g. mobile handset, of a user is stored with an identification code that can be recognized by the system operator, the mobile communication device will be allowed to send a request to the base station to request a communication service. If the request is sent within the operational territory of the system operator, the request will be received by the base station, transmitted to and processed by the system operator. Thereby, the communication between the mobile communication device and a remote mobile communication device will be established. In addition, the mobile communication system called the satellite phone system allows a mobile handset to communicate with another mobile handset through the communication satellites. Due to the intensive installation of the base station or the communication satellite, such mobile communication system is easy to access and use. Number of user grows rapidly in the recent days.

Although the mobile phone or the satellite phone is convenient the cost is relatively high. The higher cost partially comes from the high cost of the mobile communication system itself and the installation of the base stations. The other reason is the roaming service provided in such mobile communication system can not be replaced by other communication systems.

Using a mobile device such as a personal computer, a personal digital assistant with mobile communication capability to conduct mobile communication through the internet has been a well known technology. The mobile device can hook with the local wireless router through a short distance wireless communication channel, such as the wireless LAN, Bluetooth etc. The router relays information to and from the mobile device between it and the internet, such that the mobile device can communicate with a remote mobile device that is connected to the internet in a similar manner. In addition, the roaming service that allows a mobile device to switch its connection with different net sectors has become popular. In such a system, information being exchanged may include voice data and data of other media. As a conclusion, it is possible to conduct mobile communication through the internet using a mobile device. Under such a condition, users enjoy the benefits of lower communication expense and lower equipment costs.

Although mobile communication through the internet is convenient and inexpensive, some technical problems have brought difficulties in the realization of such system. One of the major technical problems rests in the fact that the IP address of the remote mobile device can not be obtained automatically.

It is well known that, according to all internet communication protocols, such as TCP/IP (Transmission Control Protocol/Internet Protocol), a mobile device shall contain an effective (legal) IP address before it is allowed to access to the internet. Such IP address represents the address of the mobile device in the internet and is essential in allowing it to receive and transmit any information. In most cases, the IP address is a permanent address, while it may be a temporary address when the mobile device is roaming among net sectors. The temporary address is an address authorized to it by a relative foreign network system based on the communication node the mobile device is currently connected. During the roaming of the mobile device, when it enters into the operational territory of the communication node of another foreign network system, it needs to register with the latter foreign network system. The new foreign network system may authorize to it a new IP address, while it may be allowed to continue to use the old IP address. As the current legal IP address changes during the roaming of the mobile device, it is not known to another mobile device. As a result, other mobile devices are not able to communicate with it, by sending messages to the current legal IP address.

Although in some roaming services, messages to and from a mobile device are transmitted through its home network system, such an approach is not compulsory. Even if other mobile devices try to request the home network system to provide the current IP address of the target mobile device, in most cases the address is not known to the home network system.

### OBJECTIVES OF THE INVENTION

The objective of this invention is to provide a novel network mobile communication device capable of communicating through the internet.

Another objective of this invention is to provide a network mobile communication device to enable the mobile handset to communicate with remote mobile handsets through the internet.

### SUMMARY OF THE INVENTION

According to this invention, the network mobile communication device comprises: a control module to connect a mobile handset and to control the operation of the mobile handset; a wireless network operation system to set operational conditions of said network mobile communication device; a wireless network hardware to include electronic components enabling the communication with a wireless access point; and a wireless network driver module to drive electronic components of said wireless network hardware. The control module of the present invention connects a local wireless access point to obtain an authenticated IP address upon the input of the identification code of a remote network mobile communication device by the user and actuates its connected mobile handset to send data of said obtained IP address to the remote network mobile communication device through the mobile communication network system connected to said mobile handset. The control module connects the local wireless access point upon the receipt of an IP address from a remote network mobile communication device and connects, through said wireless access point, the network mobile communication device represented by said IP address to establish communication.

### BRIEF DESCRIPTION OF THE DRAWINGS

These and other objectives and advantages of this invention may be clearly understood from the detailed description by referring to the following drawings.

FIG. 1 illustrates the system diagram of one embodiment of the network mobile communication device of this invention.

FIG. 2 illustrates the flowchart of the communication control of the network mobile communication device of this invention.

FIG. 3 shows the system diagram of the second embodiment of the network mobile communication device of this invention.

### DETAILED DESCRIPTION OF THE INVENTION

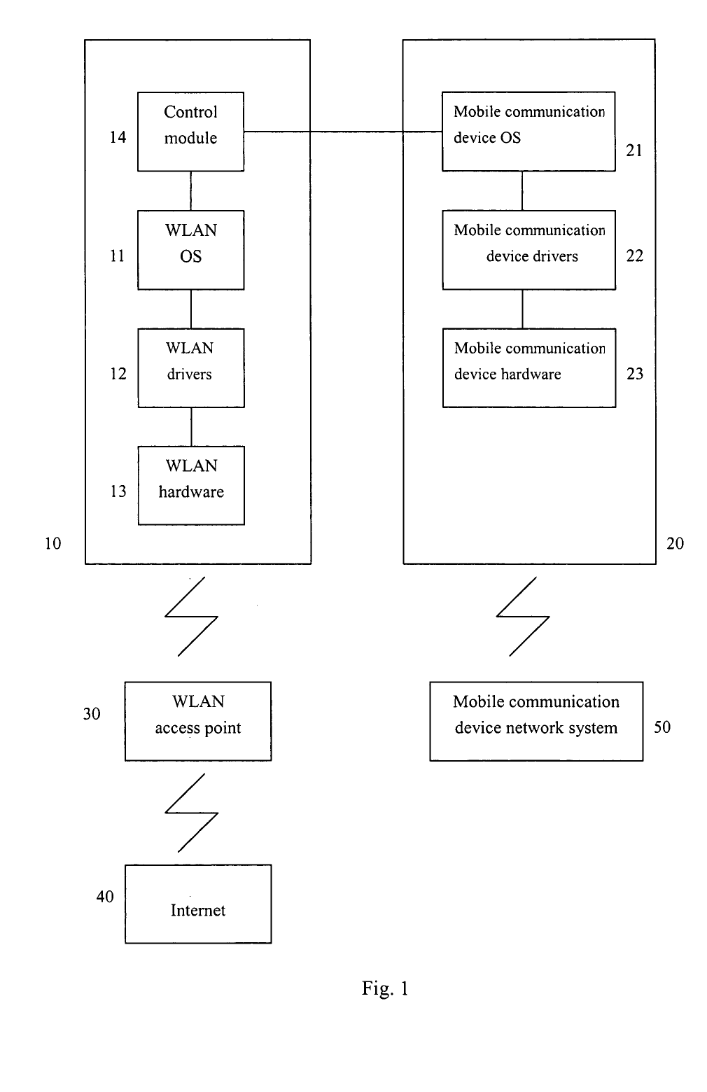

FIG. 1 illustrates the system diagram of one embodiment of the network mobile communication device of this invention. As shown in this figure, the network mobile communication device 10 is able to connect a mobile communication device 20 and a wireless access point 30. The wireless access point is connectable to the internet 40 to establish communication with other wired and wireless networks. On the other hand, the mobile communication device 20 is connectable to a mobile communication network system 50 to establish communication with other devices with mobile communication capabilities.

Also as shown in this figure, the mobile communication device 20 comprises a mobile communication device operation system 21 to set all kinds of operational conditions of the mobile communication device 20; a mobile communication device hardware 23 to include electronic components necessary in the communication with the mobile communication network system 50; and a mobile communication device driver module 22 to drive the electronic components of the mobile communication device hardware 22. Generally speaking, the mobile communication device may be an ordinary mobile handset or a satellite handset, as long as it is able to establish communication with other mobile communication device through the mobile communication network system 50. The technical features of the mobile communication device 20 are well known to those skilled in the art. Detailed description thereof is thus omitted.

The network mobile communication device 10 of this invention comprises: a control module 14 to connect the mobile communication device 20 and to control the operation of the mobile communication device 20; a wireless network operation system 11 to set operational conditions of said network mobile communication device 10; a wireless network hardware 13 to include electronic components enabling the communication with a wireless access point 30; and a wireless network driver module 12 to drive electronic components of said wireless network hardware 13. In this invention, the wireless network operation system 11, the wireless network driver module 12 and the wireless network hardware 13 may be accomplished using the technologies of known wireless network cards or wireless network chipsets. These technologies are known to those skilled in the art. Detailed description thereof is thus omitted.

One of the major features of this invention is to use the communication system of the internet to enable mobile communication functions. In order to accomplish this feature, the control module 14 of the present invention connects the local wireless access point 30 to obtain an authenticated IP address in pursuance to applicable rules or protocols in the internet, such as the dynamic host configuration protocol (DHCP), upon the input of the identification code of a remote network mobile communication device by the user. The IP address may be a dynamic IP or a permanent IP. When the IP address is obtained, the control module 14 actuates the mobile communication device 20 connected to it to dial the identification code of the remote mobile communication device to establish communication with the remote mobile communication device and sends data of the obtained IP address to the remote mobile communication device through the mobile communication network system 50 connected to both mobile communication devices. In conducting the establishment of the communication, it is assumed that the remote mobile communication device is connectable to a network mobile communication device of this invention. To avoid erroneous operation, a verification procedure to identify whether the remote mobile communication device supports the network mobile communication capability is recommended. Such verification procedure may be easily realized during the negotiation procedure using known technologies.

The control module 14 connects the local wireless access point 30 upon the receipt of an IP address from a remote network mobile communication device through the mobile communication network system 50 and connects, through said wireless access point 30, the remote mobile communication device represented by said IP address to establish communication.

In the control module 14, the dialing operation of the mobile communication device 20 and transmission of the IP address data are actuated when the user inputs the identification code of the remote network mobile communication device or when the local network mobile communication device 10 switches to a new network access point and obtains a new IP address. As a result, the remote network mobile communication device is able to be provided with currently effective IP address of the local network mobile communication device 10 from time to time.

In the embodiment of this invention, the identification code of the remote network mobile communication device may be the telephone number of the mobile communication device connected to the remote network mobile communication device or any other representative code used in the mobile communication network system 50, as long as the code enables the local mobile communication to establish communication and exchange information with the remote mobile communication device through the mobile communication network system 50. The data as sent to the remote network mobile communication device may be the currently effective IP address of the local network mobile communication device 10. The data may be sent in the form of a “short message”. Preferably the message contains control signal to effectively actuate the remote network mobile communication device. As a result, the control module of the remote network mobile communication device establishes a network communication after the message is received.

The control module 14 establishes communication with the local wireless network access point 30 after it receives the message containing the IP address data of a remote network mobile communication device. It further establishes the remote network mobile communication device through the internet 40. Thereafter, all communications between them are conducted through the internet 40, rather than through the mobile communication network 50. Communication between the local and remote mobile communication devices through the mobile communication network system 50 is thus terminated. When the connection of either network mobile communication device with its local wireless network access point is interrupted, or when either network mobile communication device switches to a new wireless network access point, the communication between both mobile communication devices through the mobile communication network system 50 is repeated, such that the communication between both network mobile communication devices is continued.

In the present invention, the communication between the network mobile communication device 20 and the network access point 30 may go through any known or applicable wireless network communication protocol, such as IEEE 802.11x.

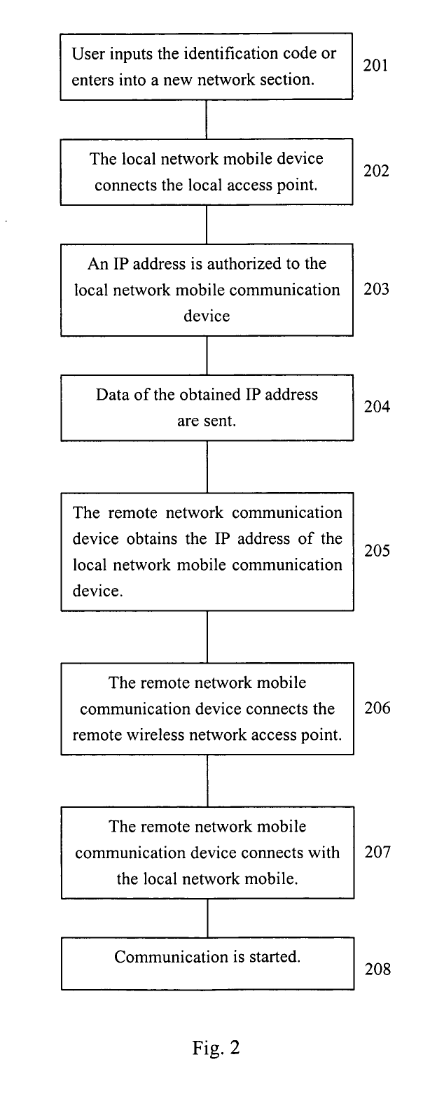

The procedure of communication control of the network mobile communication device of this invention will be described in the following. FIG. 2 illustrates the flowchart of the communication control of the network mobile communication device of this invention. As shown in this figure, at 201 user of the local network mobile communication device 10 inputs the identification code of the remote mobile communication device, or the local network mobile communication device 10 enters into a new network section. At 202 the local network mobile device 10 connects the local wireless network system 30. At 203 an IP address is authorized to the local network mobile communication device 10. At 204 the local network mobile communication device 10 actuates its connected mobile communication device 20 to dial the identification code of the remote mobile communication device, so to establish communication with the remote mobile communication device through the mobile communication network system 50 and to send data of the obtained IP address to the remote network communication device. At 205 the remote network communication device obtains the IP address of the local network mobile communication device. At 206 the remote network mobile communication device connects the remote wireless network access point. At 207 the remote network mobile communication device establishes communication with the local network mobile commutation device 10. At 208 the two network mobile communication starts to communicate through the internet 40 and the communication between the two mobile communication devices through the mobile communication network system is terminated.

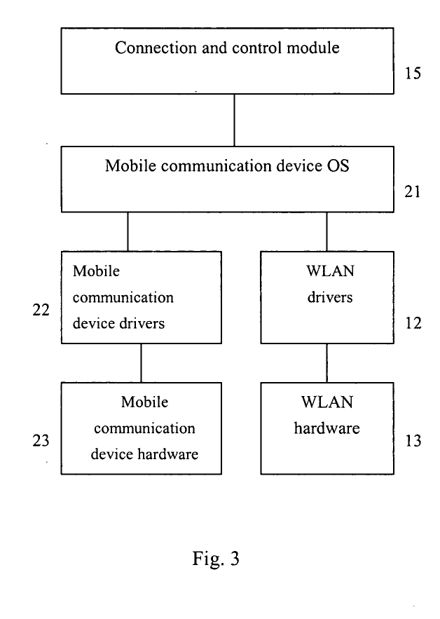

In the above embodiment, the network mobile communication 10 is independent from the mobile communication device 20. Communication between them may thus be realized through suited communication means, such as transmission line, wireless etc. In another embodiment of this invention, the network mobile communication device 10 and the mobile communication device 20 are combined into one unit. FIG. 3 shows the system diagram of the second embodiment of the network mobile communication device of this invention. In this figure, components same as those in FIG. 1 are labeled with same numbers.

As shown in FIG. 3, the network mobile communication device 10 of this embodiment comprises: a connection and control module 15 to control the wireless networking function and the mobile communication function; an operation system 21 to set operational conditions of the wireless networking function and the mobile communication function; a wireless network hardware 13 to include all necessary electronic components for the wireless networking operation; a wireless network driver module 12 to driver the electronic components of the wireless network hardware 13; a mobile communication hardware 23 to include all kinds of necessary electronic components for the mobile communication operation; and a mobile communication driver module 22 to drive the electronic components of the mobile communication hardware 23.

Under such a design, the connection and control module 15 does not only provide the functions of the control module 14 of the first embodiment but also control the functions of the mobile communication directly. The device is thus simplified, while the network mobile communication device and the mobile communication device form a unit.

As the present invention has been shown and described with reference to preferred embodiments thereof, those skilled in the art will recognize that the above and other changes may be made therein without departing form the spirit and scope of the invention.

1. A network mobile communication device comprising:
a control module to connect a mobile handset and to control the operation of the mobile handset;
a wireless network operation system to set operational conditions of said network mobile communication device;
a wireless network hardware to include electronic components enabling the communication of said network mobile communication device with a local wireless access point; and
a wireless network driver module to drive electronic components of said wireless network hardware;
wherein:
said control module connects said local wireless access point to obtain an authenticated IP address upon the input of identification code of a remote network mobile communication device by user and actuates said connected mobile handset to send data of said obtained IP address to said remote network mobile communication device through mobile communication network system connected to said mobile handset; and
said control module connects said local wireless access point upon the receipt of an IP address from a remote network mobile communication device and connects, through said local wireless access point, said remote network mobile communication device represented by said IP address to establish communication.

2. The network mobile communication device according to claim 1, wherein said identification code comprises mobile phone number of a mobile handset connected to said remote network mobile communication device.

3. The network mobile communication device according to claim 1, wherein said IP address is sent in the form of a short message.

4. A network mobile communication device, comprising:
a connection and control module to control wireless networking function and mobile communication function of said network mobile communication device;
an operation system to set operational conditions of said wireless networking function and said mobile communication function;
a wireless network hardware to include necessary electronic components said the wireless networking function;
a wireless network driver module to driver said electronic components of said wireless network hardware;
a mobile communication hardware to include necessary electronic components for said mobile communication function; and
a mobile communication driver module to drive said electronic components of said mobile communication hardware;
wherein:
said connection and control module connects a local wireless access point to obtain an authenticated IP address upon the input of identification code of a remote network mobile communication device by user and actuates said mobile communication function to send data of said obtained IP address to said remote network mobile communication device through mobile communication network system connected to said network mobile communication device; and
said connection and control module connects said local wireless access point upon the receipt of an IP address from a remote network mobile communication device and connects, through said local wireless access point, said remote network mobile communication device represented by said IP address to establish communication.

5. The network mobile communication device according to claim 4, wherein said identification code comprises mobile phone number of a mobile handset connected to said remote network mobile communication device.

6. The network mobile communication device according to claim 4, wherein said IP address is sent in the form of a short message.
